(19) United States
(12) Patent Application Publication
(10) Pub. No.: US 2008/0270152 A1
(43) Pub. Date: Oct. 30, 2008

(54) Patent Acquisition and Assertion by a (Non-Inventor) First Party Against a Second Party

(75) Inventor: Clive D. Menezes, Conroe, TX (US)

Correspondence Address: HOWARD L SPEIGHT, 9601 Katy Freeway, Suite 280, HOUSTON, TX, 77024, US

(73) Assignee: Halliburton Energy Services Inc.

(21) Appl. No.: 11/741,429

(22) Filed: Apr. 27, 2007

(51) Int. Cl. G06Q 30/00

(52) U.S. Cl. 705/1

(57) ABSTRACT

Methods for a first party to acquire and assert a patent property against a second party are disclosed. The methods include obtaining an equity interest in the patent property. The methods further include writing a claim within the scope of the patent property. The claim is written to cover a product of the second party where the product includes a secret aspect. The methods further include filing the claim with a patent office. The methods sometimes include offering a license of the patent property to the second party after the patent property issues as a patent with the claim. The methods sometimes include asserting infringement of the claim by the second party after the patent property issues as a patent with the claim. The methods sometimes include negotiating a cross-license with the second party based on the assertion of infringement of the claim, where under the cross-license the first party obtains a license to an intellectual property right from the second party. The methods sometime include attempting to obtain a monetary settlement from the second party based on the assertion of infringement of the claim.

### BACKGROUND

For the purposes of this application, a patent property is a United States or foreign patent, design patent, utility model, patent application, or other similar intellectual property. A patent property may exist before filing. For example, a patent property may include the intellectual property embodied in a patent application as it is being prepared and before it is filed. Patent properties have certain property rights that accrue to their owners. Such rights can be asserted against other parties in law suits. For example, a patent owner may file a law suit against another entity claiming that the other entity's product is infringing the patent owner's patent.

Intellectual property rights can also be used in licensing negotiations. For example, the owner or licensee of a pending patent application may send a letter to another entity warning the other entity that the patent application is on file. The owner may suggest that the other entity pay a licensing fee to continue producing a product that the owner contends will infringe when the patent application issues as a patent.

In the United States, a patent application initially belongs to the inventor or inventors. In many instances, inventors assign patent applications to their employers upon filing. The patent that issues from a patent application is typically owned by the owner of the patent application.

Rights in a patent property can be assigned or licensed. A recipient of such an assignment or license is said to own an equity interest in the patent property.

Typically, before initiating licensing discussions concerning a patent property, such as a patent or a patent application, a party insures that it has standing to bring a lawsuit over the patent property. Otherwise, the party will be negotiating from a weak position because the party will be unable to sue if the entity on the other side of the negotiations refuses to enter into a license. Under the law at the time of filing, a party has standing to bring a lawsuit over a patent if the party owns “all substantial rights” in the patent. A party has all substantial rights if, for example, it has received ownership of the patent by way of an assignment from the inventors, assuming that the inventors had not previously assigned the patent. In addition, a party may receive all substantial rights in a patent through a license. One of the rights that must be conferred through such a license in order to create standing is the right to sue under the patent.

In addition, under the Rules of Federal Procedure in effect at the time of filing a party is obligated to perform a pre-suit investigation before filing a law suit on a patent. Often, a party will perform the same pre-suit investigation before initiating licensing negotiations. A pre-suit investigation often involves drafting a “claim chart.” In the United States, a patent includes claims, which set out the metes and bounds of the patent property associated with the patent. A claim often is made up of a set of “elements” or “limitations,” which together define the scope of the claim. A patent is infringed by a product, which may be an object, a process, or the product of a process, if every element or limitation of one of the patent's claims is satisfied by the product. A claim chart is created to show the correspondence between the patent claim and the infringing product.

In many situations, it is possible to create a claim chart applying a patent claim to a product by simply examining the product. For example, if the product is an object it is usually possible to physically examine the object, possibly after disassembling it, and create the claim chart based on that examination.

Other products, however, may include an aspect that the party producing the product seeks to keep secret. For example, if a party provides a web-based service that uses software that runs on the party's computers, the party may intend for the operation of the software to be secret.

Similarly, a party may sell an object that automatically destroys a part of itself if the object is disassembled. The intention of the party may be to keep that destroyed part secret.

It is a challenge to engage in licensing negotiations or a patent lawsuit where a product asserted to be infringing includes a secret aspect.

### BRIEF DESCRIPTION OF THE DRAWINGS

FIGS. 1-3 are flow charts illustrating example embodiments of aspects of methods for patent acquisition and assertion by a (non-inventor) first party against a second party.

### DETAILED DESCRIPTION

The inventor and the assignee of this patent have no intention of applying the techniques described herein offensively but instead intend to use the patent defensively to discourage patent trolls and the like from extortionist practices.

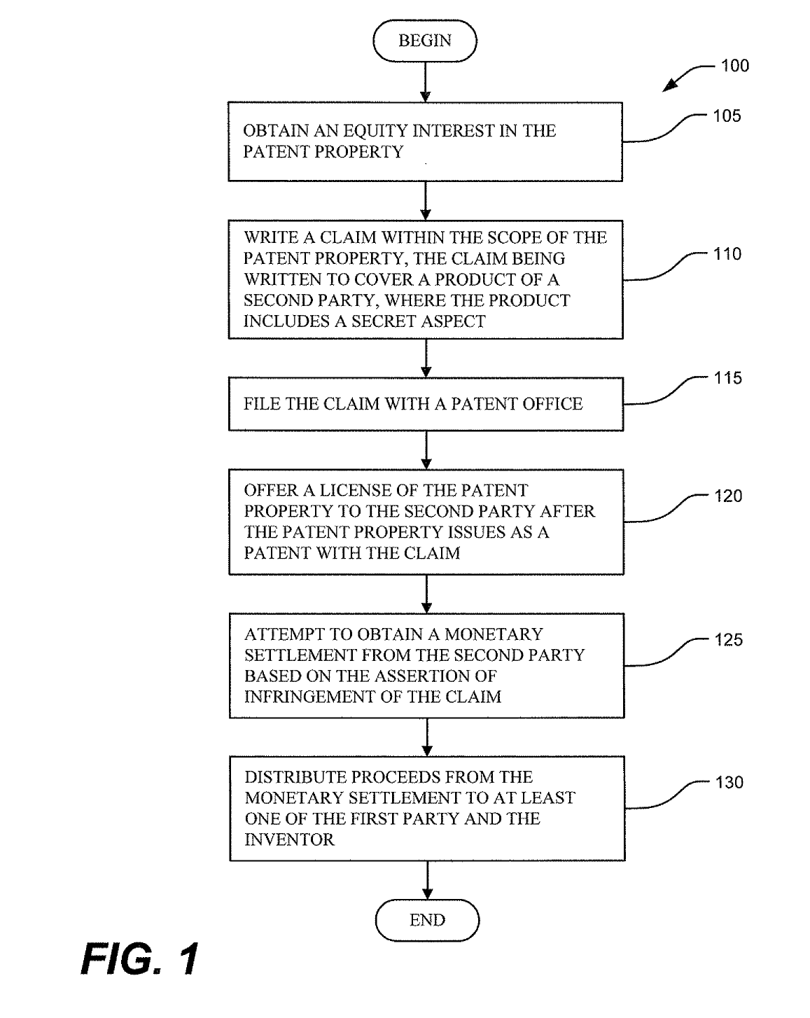

Some embodiments of methods for patent acquisition and assertion by a non-inventor first party against a second party, illustrated in FIG. 1, begin with a first party obtaining an equity interest in a patent property (block 105). In some embodiments, the first party is a company, such as a holding company, represented by a law firm. For example, the first party may be a company that is in the business of acquiring and licensing patents and patent applications. That company may hire one or more law firms to help with or actually perform the method activities. In some embodiments, the first party is a law firm. The law firm may perform the method activities directly or it may form an entity that performs the activities. The law firm may be a partner in such an entity with one or more licensing experts, investors, or other entities or individuals interested in participating in such activities.

In some embodiments, the patent property is a patent. In some embodiments, the patent property is a design patent. In some embodiments, the patent property is a utility model, a patent of addition, a confirmation patent, an importation patent, or some other form of patent recognized by a country in the world. In some embodiments, the patent property is an application for one of the forms of property described above. The patent property may be property interest recognized in the United States, a property interest recognized in a foreign country, or a property interest recognized in a group of countries. A patent application in the European Patent Office is an example of the latter.

In some embodiments, the patent property includes claims directed to a process, products, or products that are derived from a process. In some embodiments, a second party is secretly using the process as part of its operations. The secret use may be the second party's trade secret.

In some embodiments, the equity interest is obtained from an inventor or inventors of the patent property. In some embodiments, the equity interest is obtained from the current owner of the patent property. For example, the inventors of the patent property may have assigned their ownership interest in the patent property to their employer, a corporation. In that case, the equity interest would be acquired from the employer-corporation. Further, in some countries of the world title to a patent property may initially reside in the inventor's or inventors' employer. In that case, the equity interest would be acquired from the employer-corporation. As another example, the employer-corporation, having received an equity interest in the patent property from an inventor or inventors, may have transferred the equity interest in the patent property to another entity, such as a corporation or an individual. In that case, the equity interest would be acquired from the new owner-entity. Other similar situations would be apparent to persons of ordinary skill in the art.

In some embodiments, the equity interest acquired by the first party is sufficient so that the first party would have standing to file a law suit, or to bring some other action through the United States government or through a foreign government or regional government, under the equity interest. In the United States, the equity interest may be in all substantial rights in a patent. If other countries or regions of the world, the equity interest may be in other rights. In some embodiments, the equity interest may be insufficient to confer standing without joining another person or entity in a lawsuit filed under the patent property.

In some embodiments, the equity interest is acquired by an assignment. In some embodiments, the equity interest is acquired by a license. In some embodiments, the equity interest is acquired by some other means of transfer.

In some embodiments, the equity interest is acquired by paying financial consideration. For example, the first party may acquire the equity interest by paying cash, securities, bonds, or some other form of financial consideration.

In some embodiments, the equity interest is acquired by performing work. For example, the first party may acquire the equity interest by preparing the patent application that led to the patent. Alternatively, or in addition, the first party may acquire the equity interest by agreeing to prosecute a patent lawsuit under the patent without charging for time and/or expenses. Further, the first party may acquire the equity interest by agreeing to pay the law firm that prosecutes a law suit under the patent.

In some embodiments, the equity interest is acquired by paying less for the patent property than it is worth.

In some embodiments, the equity interest is acquired by obtaining all substantial rights in the patent property. The first party may make this acquisition through an assignment or through a license. The license may be an exclusive license.

In some embodiments, the equity interest is acquired by obtaining one or more of the rights to make, use, sell, offer to sell, or import into the United States articles within the scope of the patent property.

In some embodiments, the equity interest is obtained with the intent of using the patent property exclusively to generate revenue from other parties through assertions of infringement against those parties. For example, the first party may be a law firm and it may acquire a patent that covers certain technology that the law firm has no intention of practicing. Instead, the law firm may have acquired the patent for the purpose of licensing it to companies that are practicing the invention described in the patent.

Referring again to FIG. 1, in some embodiments the method continues with the first party writing a claim within the scope of the patent property that covers a product of the second party, where the product includes a secret aspect (block 110). In some embodiments, the scope of the claim is determined by the then-prevailing laws of the country or countries where the patent property is recognized. For example, in the United States, the law of claim interpretation arises from the Patent Statute, 35 U.S.C. § 101, et seq., and case law. The first party would be aware of the law of the country or countries where the patent property is recognized and tailor the claim to the desired scope.

In some embodiments, the first party would also be aware that the product of the second party includes a secret aspect and would write the claim to cover that secret aspect. For example, the product of the second party may include observable aspects and unobservable aspects, the latter of which would also be classified as secret aspects. The first party may research the product of the second party to a reasonable extent to convert as many unobservable aspects to observable aspects as possible. The first party may then make reasonable inferences or deductions about the unobservable aspects and write the claim accordingly.

Referring again to FIG. 1, in some embodiments the method continues with the first party filing the claim with a patent office (block 115). In some embodiments, the patent office is the United States Patent and Trademark Office. In some embodiments, the patent office is the patent office of a foreign country, such as Germany or the United Kingdom. In some embodiments, the patent office is that of a region, such as the European Patent Office. In some embodiments, the patent office may be implementing a patent treaty, such as the United States Patent and Trademark Office or the European Patent Office operating under the Patent Cooperation Treaty.

In some embodiments, the claim may be filed as part of a continuation application. In some embodiments, filing the claim may be filed as part of a divisional application. In some embodiments, the claim may be filed as part of a reissue application. In some embodiments, the claim may be filed as part of a reexamination proceeding. In some embodiments, the first party may take over prosecution of a patent application and file the claim as part of that activity.

Referring again to FIG. 1, in some embodiments the method continues, after the patent property issues as a patent including the claim, with the first party offering a license of the patent property to the second party (block 120). In some embodiments, this is accomplished by informing the second party of the existence of the claim. In some embodiments, the method includes asserting infringement of the claim by the second party if the license offer is rejected by the second party. In some embodiments, this is accomplished by the first party sending the second party a letter accusing the second party of infringing the patent. In some embodiments, the letter includes an invitation for the second party to enter into licensing discussions with the first party. In some embodiments, the letter does not include such an invitation but instead simply purports to bring the patent to the attention of the second party. In some embodiments, the letter offers the second party an opportunity to purchase the patent.

In some embodiments, the first party may assert infringement of the claim by filing a lawsuit in which the second party is accused of infringing the patent. In some embodiments the second party may have previously sued the first party, and the first party asserts infringement of the claim by filing a counterclaim against the second party in that lawsuit accusing the second party of infringing the patent. In some embodiments the previous law suit brought by the second party may have been a declaratory judgment law suit against the first party asserting that the patent is invalid. In some embodiments the previous law suit brought by the second party may have been a declaratory judgment law suit against the first party asserting that the patent is not infringed by the second party. In some embodiments the previous law suit brought by the second party may have been a declaratory judgment law suit against the first party asserting that the patent is not enforceable.

In some embodiments, the first party may assert infringement of the claims by filing an action before the International Trade Commission in which the second party is accused of infringing the patent.

In some embodiments, the first party determines the identity of the second party by searching the business practices of the second party through one or more databases. For example, the first party may determine the identity of the second party by performing research on the Internet using a search engine such as Google™. Further, the first party may use databases available through the Internet, such as those provided by the Securities Exchange Commission (the “SEC”) or Dunn & Bradstreet. Such databases may include descriptions of the business practices of the second party authored by the second party or its representatives or by one or more third parties.

In some embodiments, the first party may determine the identity of the second party by reviewing publicly accessible data regarding the intellectual property portfolio of the second party. For example, the first party may use the search tools available on the United States Patent and Trademark Office's web page or other similar search tools that allow a user to research and view the contents of patent properties in the United States and throughout the world.

In most cases, such databases allow the user to search for patent properties owned by the second party. Further, many of such databases allow the user to search for patent properties prepared for the benefit of the second party but which are now owned by another entity. For example, the second party may have had a patent application prepared for an invention owned by one of its employees. The employee may have assigned the patent application to the second party, which may have then assigned the patent application or the patent that issued from that application to another entity. The first party may use such patent properties as sources of information about the business practices of the second party. For example, a patent may describe a particular technology that the second party uses in its business. In addition, a patent application may describe a business method that the second party employs in its business. In some embodiments of the method described herein, such information is useful in identifying the second party.

Such databases sometimes provide for each patent property a list of other patent properties that reference it. For example, patents in the United States include on their first page, and sometimes on continuation pages, a list of patents that site that patent. Such references may practice the same technology, and in some cases the invention, described in the patent. Consequently, to practice the technology described in such references it is necessary to practice the invention described in the patent. In some embodiments, the first party uses such information to identify the second party.

Referring again to FIG. 1 in some embodiments the method continues with the first party attempting to obtain a monetary settlement from the second party based on the assertion of infringement of the claim (block 125). The second party may pay the monetary settlement to the first party to settle a law suit, to avoid a law suit, or to avoid some other action by the first party. The monetary settlement may be in the form of cash, bonds, or securities. It may be a lump sum or in the form of a promise to pay sums in the future. The promise to pay in the future may be sums certain or the amount may vary depending, for example, on the revenues earned by the second party or by another entity. The promise to pay in the future may be contingent on an event. For example, the promise may be contingent on a finding in another lawsuit, or in the same lawsuit against another party, that the patent property is not invalid.

Referring again to FIG. 1, in some embodiments the method continues with the first party distributing proceeds from the monetary settlement to at least one of the first party and the inventor (block 130). For example, the first party and the inventor may have a contract, such as an engagement letter, under which the proceeds from the monetary settlement are paid according to a formula. Under one example formula, the expenses of the lawsuit would be reimbursed first, followed by a division of the remainder between the inventor, who might receive sixty percent, and the first party, who might receive forty percent. A portion of the proceeds might be stored in a “war chest” for future lawsuits.

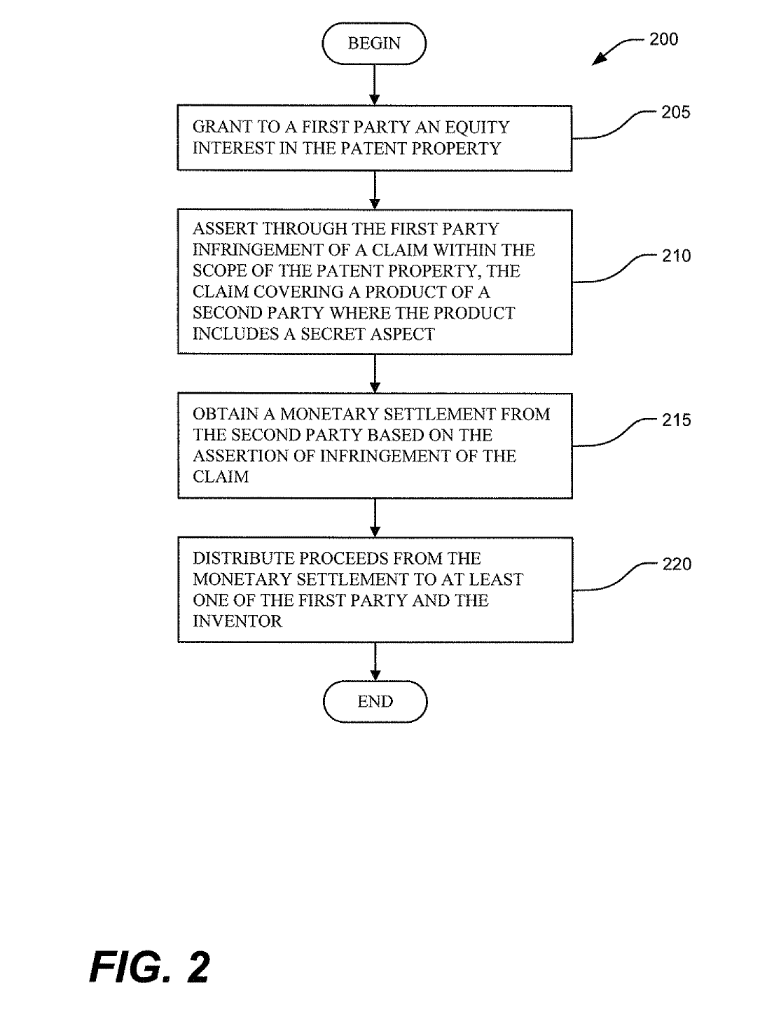

In some embodiments, illustrated in FIG. 2, an inventor asserts a patent property through a first party against a second party (200). In some embodiments, the inventor grants to a first party an equity interest in the patent property (block 205). The inventor, through the first party, asserts infringement of a claim within the scope of the patent property (block 210). The claim covers a product of a second party. The product includes a secret aspect.

The inventor then obtains a monetary settlement from the second party based on the assertion of infringement of the claim (block 215). The inventor then distributes proceeds from the monetary settlement to at least one of the first party and the second party (block 220).

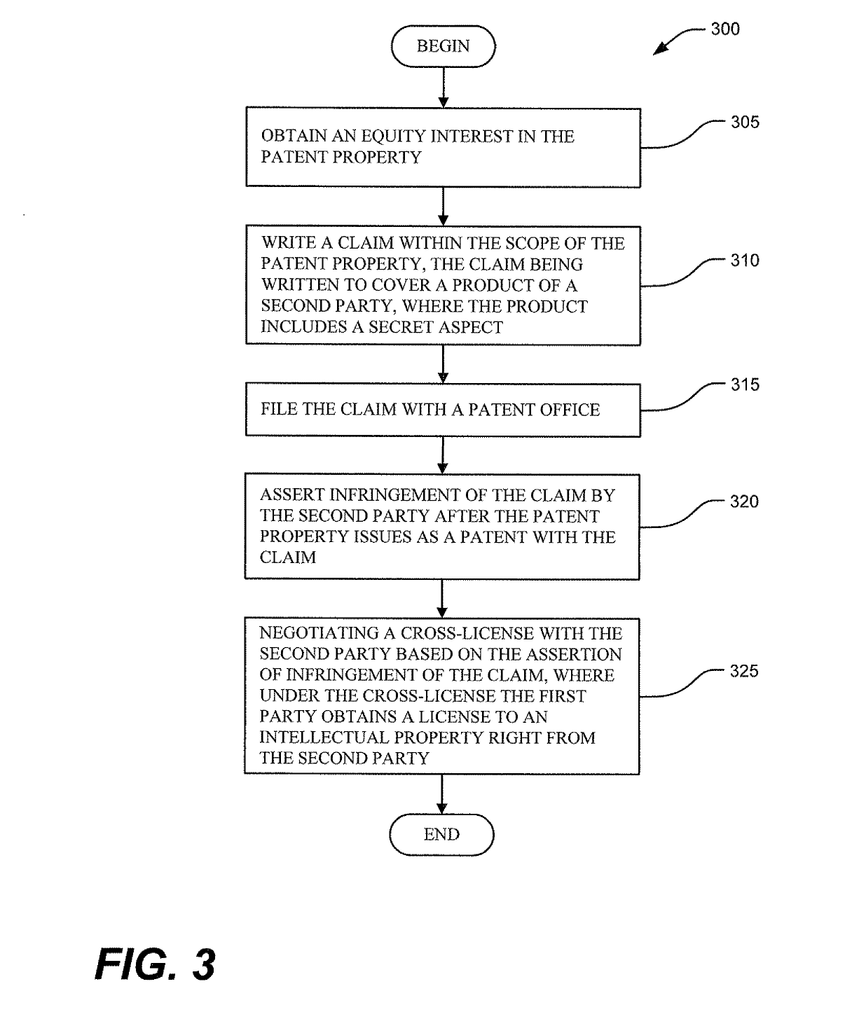

In some embodiments, illustrated in FIG. 3, a non-inventor first party acquires and asserts a patent property against a second party (300). In some embodiments, the first party obtains an equity interest in the patent property (block 305).

In some embodiments, the first party then writes a claim within the scope of the patent property (block 310). The claim is written to cover a product of the second party. The product includes a secret aspect.

In some embodiments, the first party files a claim with a patent office (block 315).

In some embodiments, after the patent property issues as a patent including the claim the first party asserts infringement of the claim by the second party (block 320). In some embodiments, the first party then negotiates a cross-license with the second party based on the assertion of infringement of the claim (block 325). In some embodiments, the cross-license results in the first party obtaining a license to an intellectual property from the second party. The intellectual property may a patent property owned by the second party or a patent property to which the second party has a license. In some embodiments, the intellectual property is a trademark. In some embodiments, the intellectual property is a trade secret. In some embodiments, the intellectual property is recognized in the United States. In some embodiments, the intellectual property is recognized in a foreign country or region.

The text above describes one or more specific embodiments of a broader invention. The invention also is carried out in a variety of alternate embodiments and thus is not limited to those described here. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A method for a non-inventor first party to acquire and assert a patent property against a second party, the method including the first party performing the following acts:
obtaining an equity interest in the patent property;
writing a claim within the scope of the patent property, the claim being written to cover a product of the second party, where the product includes a secret aspect, the secret aspect including an unobservable aspect, where writing the claim includes performing research using a computer to convert the unobservable aspect to an observable aspect;
filing the claim with a patent office;
offering a license of the patent property to the second party after the patent property issues as a patent with the claim; and
attempting to obtain a monetary settlement from the second party based on the assertion of infringement of the claim.

2. The method of claim 1 further including:
distributing proceeds from the monetary settlement to at least one of the first party and the inventor.

3. The method of claim 1 where obtaining the equity interest in the patent property includes at least one of:
obtaining an equity interest in a patent and/or a patent application.

4. The method of claim 1 where obtaining the equity interest in the patent property includes at least one or:
obtaining the equity interest from an inventor of the patent property and/or obtaining the equity interest from an owner of the patent property.

5. The method of claim 1 wherein obtaining the equity interest in the patent property includes:
paying financial consideration for the equity interest.

6. The method of claim 1 wherein obtaining the equity interest in the patent property includes:
performing work in exchange for the equity interest.

7. The method of claim 1 wherein obtaining the equity interest in the patent property includes:
paying less for the patent property than it is worth.

8. The method of claim 1 wherein obtaining the equity interest in the patent property includes:
obtaining all substantial rights in the patent property.

9. The method of claim 1 wherein obtaining the equity interest in the patent property includes:
obtaining one or more of the rights to make use, sell, offer to sell, or import into the United States articles within the scope of the patent property.

10. The method of claim 1 wherein obtaining the equity interest in the patent property includes:
obtaining the equity interest with the intent of using the patent property exclusively to generate revenue from other parties through assertions of infringement against those parties.

11. The method of claim 1 where writing the claim within the scope of the patent property includes:
writing the claim to cover a process including an aspect practiced secretly by the second party.

12. The method of claim 1 where writing the claim within the scope of the patent property includes:
writing the claim to cover a product produced by a process including an aspect practiced secretly by the second party.

13. The method of claim 1 where the secret aspect includes unobservable aspects and where writing the claim includes:
performing research to convert some of the unobservable aspects to observable aspects.

14. The method of claim 1 where the secret aspect includes unobservable aspects and where writing the claim includes:
performing research to convert some of the unobservable aspects to observable aspects; and
making inferences about the remaining unobservable aspects.

15. The method of claim 1 where the secret aspect includes unobservable aspects and where writing the claim includes:
performing research to convert some of the unobservable aspects to observable aspects; and
making deductions about the remaining unobservable aspects.

16. The method of claim 1 where filing the claim with the patent office includes: filing the claim with the United States Patent and Trademark Office.

17. The method of claim 1 where filing the claim with the patent office includes:
filing the claim with a patent office of a foreign country.

18. The method of claim 1 where filing the claim with the patent office includes:
filing the claim with a patent office implementing a patent treaty.

19. The method of claim 1 where filing the claim with the patent office includes:
filing the claim as part of at least one of a continuation application and/or a divisional application.

20. The method of claim 1 where filing the claim with the patent office includes:
filing the claim as part of a reissue application.

21. The method of claim 1 where filing the claim with the patent office includes:
filing the claim during a reexamination proceeding.

22. The method of claim 1 where filing the claim with the patent office includes:
taking over prosecution of the patent property and filing the claim during that prosecution.

23. The method of claim 1 wherein offering a license of the patent property to the second party after the patent property issues as a patent with the claim comprises:
informing the second party of the existence of the claim.

24. The method of claim 1 further including:
asserting infringement of the claim by the second party if the license offer is rejected by the second party.

25. The method of claim 24 where asserting infringement of the claim includes:
sending the second party a letter accusing the second party of infringing the patent.

26. The method of claim 24 where asserting infringement of the claim includes:
filing a lawsuit against the second party in which the second party is accused of infringing the patent.

27. The method of claim 24 where asserting infringement of the claim includes:
filing a counterclaim against the second party in a suit brought against the first party by the second party.

28. The method of claim 24 where asserting infringement of the claim includes:
filing a counterclaim against the second party in a declaratory judgment suit brought against the first party by the second party in which the second party asserts that the patent is invalid.

29. The method of claim 24 where asserting infringement of the claim includes:
filing a counterclaim against the second party in a declaratory judgment suit brought against the first party by the second party in which the second party asserts that the patent is not infringed.

30. The method of claim 24 where asserting infringement of the claim includes:
filing a counterclaim against the second party in a declaratory judgment suit brought against the first party by the second party in which the second party asserts that the patent is unenforceable.

31. The method of claim 24 where asserting infringement of the claim includes:
initiating an action against the second party before the International Trade Commission in which the second party is accused of infringing the patent.

32. The method of claim 1 further including:
determining the identity of the second party by searching business practices of the second party through one or more databases.

33. The method of claim 1 further including:
determining the identity of the second party by reviewing publicly accessible data regarding an intellectual property portfolio of the second party.

34. The method of claim 33 where reviewing the publicly accessible data regarding the intellectual property portfolio of the second party includes reviewing a database maintained by a patent office for patent properties filed for the benefit of the second party.

35. The method of claim 33 where reviewing the publicly accessible data regarding the intellectual property portfolio of the second party includes reviewing a database maintained by a patent office for patent properties owned by the second party.

36. The method of claim 1 further including:
determining the identity of the second party by reviewing other patents that reference the patent.

36. The method of claim 1 further including:
determining the identity of the second party by reviewing other patents that reference the patent.

37. A method to assert a patent property by a first party against a second party, the method including:
obtaining by the first party an equity interest in the patent property;
asserting by the first party infringement of a claim within the scope of the patent property, the claim covering a product of the second party where the product includes a secret aspect, the secret aspect including an unobservable aspect, the unobservable aspect being converted to an observable aspect by performing research using a computer; and
attempting to obtain a monetary settlement from the second party based on the assertion of infringement of the claim.

38. The method of claim 37 wherein the first party is an inventor.

39. The method of claim 37 further including:
distributing proceeds from the monetary settlement to at least one of the first party and the inventor.

40. The method of claim 37 where obtaining the equity interest in the patent property includes:
obtaining an equity interest in a patent.

41. The method of claim 37 where obtaining the equity interest in the patent property includes:
obtaining an equity interest in a patent application.

42. The method of claim 37 where obtaining the equity interest in the patent property includes:
obtaining the equity interest from an inventor of the patent property.

43. The method of claim 37 where obtaining the equity interest in the patent property includes:
obtaining the equity interest from an owner of the patent property.

44. The method of claim 37 wherein obtaining the equity interest in the patent property includes:
paying financial consideration for the equity interest.

45. The method of claim 37 wherein obtaining the equity interest in the patent property includes:
performing work in exchange for the equity interest.

46. The method of claim 37 wherein obtaining the equity interest in the patent property includes:
performing legal work in exchange for the equity interest.

47. The method of claim 37 wherein obtaining the equity interest in the patent property includes:
paying less for the patent property than it is worth.

48. The method of claim 37 wherein obtaining the equity interest in the patent property includes:
obtaining all substantial rights in the patent property.

49. The method of claim 37 wherein obtaining the equity interest in the patent property includes:
obtaining one or more of the rights to make use, sell, offer to sell, or import into the United States articles within the scope of the patent property.

50. The method of claim 37 wherein obtaining the equity interest in the patent property includes:
obtaining the equity interest with the intent of using the patent property exclusively to generate revenue from other parties through assertions of infringement against those parties.

51. The method of claim 37 where asserting infringement of the claim includes:
sending the second party a letter accusing the second party of infringing the patent.

52. The method of claim 37 where asserting infringement of the claim includes:
filing a lawsuit against the second party in which the second party is accused of infringing the patent.

53. The method of claim 37 where asserting infringement of the claim includes:
filing a counterclaim against the second party in a suit brought against the first party by the second party.

54. The method of claim 37 where asserting infringement of the claim includes:
filing a counterclaim against the second party in a declaratory judgment suit brought against the first party by the second party in which the second party asserts that the patent is invalid.

55. The method of claim 37 where asserting infringement of the claim includes:
filing a counterclaim against the second party in a declaratory judgment suit brought against the first party by the second party in which the second party asserts that the patent is not infringed.

56. The method of claim 37 where asserting infringement of the claim includes:
filing a counterclaim against the second party in a declaratory judgment suit brought against the first party by the second party in which the second party asserts that the patent is unenforceable.

57. The method of claim 37 where asserting infringement of the claim includes:
initiating an action against the second party before the International Trade Commission in which the second party is accused of infringing the patent.

58. The method of claim 37 further including:
determining the identity of the second party by searching business practices of the second party through one or more databases.

59. The method of claim 37 further including:
determining the identity of the second party by reviewing publicly accessible data regarding an intellectual property portfolio of the second party.

60. The method of claim 59 where reviewing the publicly accessible data regarding the intellectual property portfolio of the second party includes reviewing a database maintained by a patent office for patent properties filed for the benefit of the second party.

61. The method of claim 59 where reviewing the publicly accessible data regarding the intellectual property portfolio of the second party includes reviewing a database maintained by a patent office for patent properties owned by the second party.

62. The method of claim 37 further including:
determining the identity of the second party by reviewing other patents that reference the patent.

63. A method for a non-inventor first party to acquire and assert a patent property against a second party, the method including the first party performing the following acts:
obtaining an equity interest in the patent property;
writing a claim within the scope of the patent property, the claim being written to cover a product of the second party where the product includes a secret aspect, the secret aspect including an unobservable aspect, where writing the claim includes performing research using a computer to convert the unobservable aspect to an observable aspect;
filing the claim with a patent office;
asserting infringement of the claim by the second party after the patent property issues as a patent with the claim;
negotiating a cross-license with the second party based on the assertion of infringement of the claim, where under the cross-license the first party obtains a license to an intellectual property right from the second party.

64. The method of claim 63 where obtaining the equity interest in the patent property includes:
obtaining an equity interest in a patent.

65. The method of claim 63 where obtaining the equity interest in the patent property includes:
obtaining an equity interest in a patent application.

66. The method of claim 63 where obtaining the equity interest in the patent property includes:
obtaining the equity interest from an inventor of the patent property.

66. The method of claim 63 where obtaining the equity interest in the patent property includes:
obtaining the equity interest from an owner of the patent property.

67. The method of claim 63 wherein obtaining the equity interest in the patent property includes:
paying financial consideration for the equity interest.

68. The method of claim 63 wherein obtaining the equity interest in the patent property includes:
performing work in exchange for the equity interest.

69. The method of claim 63 wherein obtaining the equity interest in the patent property includes:
performing legal work in exchange for the equity interest.

70. The method of claim 63 wherein obtaining the equity interest in the patent property includes:
paying less for the patent property than it is worth.

71. The method of claim 63 wherein obtaining the equity interest in the patent property includes:
obtaining all substantial rights in the patent property.

72. The method of claim 63 wherein obtaining the equity interest in the patent property includes:
obtaining one or more of the rights to make use, sell, offer to sell, or import into the United States articles within the scope of the patent property.

73. The method of claim 63 wherein obtaining the equity interest in the patent property includes:
obtaining the equity interest with the intent of using the patent property exclusively to generate revenue from other parties through assertions of infringement against those parties.

74. The method of claim 63 where writing the claim within the scope of the patent property includes:
writing the claim to cover a process including an aspect practiced secretly by the second party.

75. The method of claim 63 where writing the claim within the scope of the patent property includes:
writing the claim to cover a product produced by a process including an aspect practiced secretly by the second party.

76. The method of claim 63 where the secret aspect includes unobservable aspects and where writing the claim includes:
performing research to convert some of the unobservable aspects to observable aspects.

77. The method of claim 63 where the secret aspect includes unobservable aspects and where writing the claim includes:
performing research to convert some of the unobservable aspects to observable aspects; and
making inferences about the remaining unobservable aspects.

78. The method of claim 63 where the secret aspect includes unobservable aspects and where writing the claim includes:
performing research to convert some of the unobservable aspects to observable aspects; and
making deductions about the remaining unobservable aspects.

79. The method of claim 63 where filing the claim with the patent office includes:
filing the claim with the United States Patent and Trademark Office.

80. The method of claim 63 where filing the claim with the patent office includes:
filing the claim with a patent office of a foreign country.

81. The method of claim 63 where filing the claim with the patent office includes:
filing the claim with a regional patent office.

82. The method of claim 63 where filing the claim with the patent office includes:
filing the claim with a patent office implementing a patent treaty.

83. The method of claim 63 where filing the claim with the patent office includes:
filing the claim as part of a continuation application.

84. The method of claim 63 where filing the claim with the patent office includes:
filing the claim as part of a divisional application.

85. The method of claim 63 where filing the claim with the patent office includes:
filing the claim as part of a reissue application.

86. The method of claim 63 where filing the claim with the patent office includes:
filing the claim during a reexamination proceeding.

87. The method of claim 63 where filing the claim with the patent office includes:
taking over prosecution of the patent property and filing the claim during that prosecution.

88. The method of claim 63 where asserting infringement of the claim includes:
sending the second party a letter accusing the second party of infringing the patent.

89. The method of claim 63 where asserting infringement of the claim includes:
filing a lawsuit against the second party in which the second party is accused of infringing the patent.

90. The method of claim 63 where asserting infringement of the claim includes:
filing a counterclaim against the second party in a suit brought against the first party by the second party.

91. The method of claim 63 where asserting infringement of the claim includes:
filing a counterclaim against the second party in a declaratory judgment suit brought against the first party by the second party in which the second party asserts that the patent is invalid.

92. The method of claim 63 where asserting infringement of the claim includes:
filing a counterclaim against the second party in a declaratory judgment suit brought against the first party by the second party in which the second party asserts that the patent is not infringed.

93. The method of claim 63 where asserting infringement of the claim includes:
filing a counterclaim against the second party in a declaratory judgment suit brought against the first party by the second party in which the second party asserts that the patent is unenforceable.

94. The method of claim 63 where asserting infringement of the claim includes:
initiating an action against the second party before the International Trade Commission in which the second party is accused of infringing the patent.

95. The method of claim 63 further including:
determining the identity of the second party by searching business practices of the second party through one or more databases.

96. The method of claim 63 further including:
determining the identity of the second party by reviewing publicly accessible data regarding an intellectual property portfolio of the second party.

97. The method of claim 96 where reviewing the publicly accessible data regarding the intellectual property portfolio of the second party includes reviewing a database maintained by a patent office for patent properties filed for the benefit of the second party.

98. The method of claim 96 where reviewing the publicly accessible data regarding the intellectual property portfolio of the second party includes reviewing a database maintained by a patent office for patent properties owned by the second party.

99. The method of claim 63 further including:
determining the identity of the second party by reviewing other patents that reference the patent.
